(19) United States
(12) Patent Application Publication
(10) Pub. No.: US 2026/0195816 A1
(43) Pub. Date: Jul. 9, 2026

(54) ATMS.com Global Financial DAO Charter: A Blockchain-Based Decentralized Autonomous Organization Ecosystem for Comprehensive Global Financial, Banking, Payment, Asset Management, and Decentralized Finance (DeFi) Governance

(71) Applicant: FURONG BEI, SAN GABRIEL, CA (US)

(72) Inventor: FURONG BEI, SAN GABRIEL, CA (US)

(21) Appl. No.: 19/079,378

(22) Filed: Mar. 13, 2025

Related U.S. Application Data
(63) Continuation-in-part of application No. 19/066,179, filed on Feb. 28, 2025, now abandoned.
(63) Continuation-in-part of application No. 19/070,545, filed on Mar. 5, 2025.
(63) Continuation-in-part of application No. 19/054,778, filed on Feb. 15, 2025, now abandoned.
(63) Continuation-in-part of application No. 19/060,403, filed on Feb. 21, 2025, now abandoned.
(63) Continuation-in-part of application No. 19/058,739, filed on Feb. 20, 2025.
(63) Continuation-in-part of application No. 19/060,663, filed on Feb. 22, 2025.
(63) Continuation-in-part of application No. 19/067,888, filed on Mar. 1, 2025, now abandoned.
(63) Continuation-in-part of application No. 19/070,548, filed on Mar. 5, 2025.
(63) Continuation-in-part of application No. 19/072,412, filed on Mar. 6, 2025.
(63) Continuation-in-part of application No. 19/073,040, filed on Mar. 7, 2025.
(63) Continuation-in-part of application No. 19/056,745, filed on Feb. 19, 2025.
(63) Continuation-in-part of application No. 19/066,022, filed on Feb. 27, 2025, now abandoned.
(63) Continuation-in-part of application No. 19/067,732, filed on Feb. 28, 2025.
(63) Continuation-in-part of application No. 19/072,953, filed on Mar. 6, 2025.
(63) Continuation-in-part of application No. 19/053,406, filed on Feb. 13, 2025, now abandoned.
(63) Continuation-in-part of application No. 19/057,972, filed on Feb. 19, 2025, now abandoned.
(63) Continuation-in-part of application No. 19/059,324, filed on Feb. 21, 2025, now abandoned.
(63) Continuation-in-part of application No. 19/067,936, filed on Mar. 2, 2025.
(63) Continuation-in-part of application No. 19/067,907, filed on Mar. 2, 2025.
(63) Continuation-in-part of application No. 19/072,905, filed on Mar. 6, 2025.
(63) Continuation-in-part of application No. 19/069,257, filed on Mar. 4, 2025.
(63) Continuation-in-part of application No. 19/059,110, filed on Feb. 20, 2025, now abandoned.
(63) Continuation-in-part of application No. 19/053,450, filed on Feb. 14, 2025, now abandoned.
(63) Continuation-in-part of application No. 19/069,285, filed on Mar. 4, 2025.
(63) Continuation-in-part of application No. 19/069,278, filed on Mar. 4, 2025.
(63) Continuation-in-part of application No. 19/074,352, filed on Mar. 8, 2025.
(63) Continuation-in-part of application No. 19/078,271, filed on Mar. 12, 2025.
(63) Continuation-in-part of application No. 19/060,652, filed on Feb. 22, 2025, now abandoned.
(63) Continuation-in-part of application No. 19/078,276, filed on Mar. 13, 2025.
(63) Continuation-in-part of application No. 19/059,289, filed on Feb. 21, 2025, now abandoned.
(63) Continuation-in-part of application No. 19/064,689, filed on Feb. 27, 2025.
(63) Continuation-in-part of application No. 19/069,205, filed on Mar. 3, 2025.
(63) Continuation-in-part of application No. 19/072,075, filed on Mar. 6, 2025.
(63) Continuation-in-part of application No. 19/073,042, filed on Mar. 7, 2025.
(63) Continuation-in-part of application No. 19/074,355, filed on Mar. 8, 2025.
(63) Continuation-in-part of application No. 19/051,584, filed on Feb. 12, 2025, now abandoned.
(63) Continuation-in-part of application No. 19/067,845, filed on Mar. 1, 2025.
(63) Continuation-in-part of application No. 19/069,264, filed on Mar. 4, 2025.
(63) Continuation-in-part of application No. 19/076,910, filed on Mar. 11, 2025.
(63) Continuation-in-part of application No. 19/069,268, filed on Mar. 4, 2025.
(63) Continuation-in-part of application No. 19/073,058, filed on Mar. 7, 2025.
(63) Continuation-in-part of application No. 19/051,353, filed on Feb. 12, 2025, now abandoned.
(63) Continuation-in-part of application No. 19/057,393, filed on Feb. 19, 2025, now abandoned.
(60) Provisional application No. 63/759,784, filed on Feb. 18, 2025.

(51) Int. Cl. G06Q 40/06; G06Q 20/40; G06Q 40/02

(52) U.S. Cl. CPC G06Q 40/06; G06Q 20/401; G06Q 40/022

(57) ABSTRACT

A computer-implemented ATMS platform processes domain-resolved banking events using signed node manifests, decentralized identity proofs, digital financial passports, behavior evidence, and signed prudential profiles. A namespace registry links domains or subdomains to executable endpoints, vault controls, and profile identifiers. An identity-anchor module verifies subject credentials or compliance proofs, and a prudential profile engine derives credit, issuance, reserve, or liquidation outcomes from verified activity, collateral state, and treasury state. A transaction authorization and issuance engine updates token, reserve, vault, or loan state when permitted, and a route selector chooses a blockchain, cross-chain, layer-2, or hybrid settlement rail. A settlement coordinator performs linked state updates and a receipt generator anchors decision, issuance, and settlement receipts by a common digest, enabling auditable banking, lending, self-minting vaults, tokenized-asset collateralization, co-ownership allocation, and sector-node deployment.

### CROSS-REFERENCE TO RELATED APPLICATIONS

This application is drafted as an ATMS continuation-in-part style companion filing directed to a domain-resolved banking and asset orchestration platform that combines decentralized identity, digital financial passports, behavior-linked issuance, prudential profile control, tokenized collateral, co-ownership participation tokens, and multi-rail settlement. Any domestic benefit, continuation, continuation-in-part, divisional, or other continuity relationship intended to be relied upon should be stated in a corresponding Application Data Sheet.

A principal pending parent and technical backbone for the present architecture is U.S. application Ser. No. 19/056,745, filed Feb. 19, 2025, which discloses domain-based namespace control, sub-bank smart contracts, AI-driven risk control, pluggable compliance, cross-ledger exchange, multi-currency management, collateral and liquidation control, brand-franchise expansion, and co-ownership token structures.

The principal parent and companion ATMS branches for the present architecture further include: Ser. No. 19/079,378 (domain-resolved payment and settlement, NFT collateralization, AI liquidity management, self-sovereign identity, know-your-customer and anti-money-laundering controls, and quantum-resistant security); Ser. No. 19/078,276 (identity, authorization, routing, settlement, and audit infrastructure); Ser. No. 19/080,825 (policy-controlled transaction and settlement infrastructure); Ser. No. 19/083,430 (governance, domain-banking node, lending, and settlement subject matter); Ser. No. 19/072,412 (real-time payment processing, foreign-exchange optimization, route selection, settlement, and compliance intervention); Ser. No. 19/072,953 (asset collateralization, AI valuation, risk thresholding, and real-time liquidation); Ser. No. 19/072,075 (quantum-secured finance, AI credit management, governance architecture, co-ownership tokens, and cross-chain payment gateway); Ser. No. 19/074,352 (AI-driven autonomous banking, asset tokenization, NFT fractionalization, collateralized lending, and decentralized governance); Ser. No. 19/074,355 (multi-dimensional financial security, distributed routing, AI dynamic risk control, smart-contract security, and quantum-resistant encryption); Ser. No. 19/076,910 (decentralized identity, NFT collateral, digital-asset verification, and cross-chain digital-asset governance); Ser. No. 19/084,779 (decentralized identity, zero-knowledge proof authentication, biometric authentication, cross-chain identity verification, and quantum-resistant credentials); and Ser. No. 19/084,806 (banking, transaction, claim, and settlement infrastructure).

Earlier same-date roots that are preserved herein for technical continuity of ideas, contextual support, and optional branch embodiments include U.S. Application No. Ser. No. 19/051,353, filed Feb. 12, 2025, directed to an ATMS. com decentralized financial system including subdomain-based financial identity, digital financial passports, self-minting vaults, AI credit scoring and lending, NFT asset tokenization, decentralized lending, cross-border stablecoin payments, and DAO policy control; and U.S. application Ser. No. 19/051,584, filed Feb. 12, 2025, directed to a 24HWS. com global chain ecosystem including domain-resource infrastructure, blockchain and AI integration, NFT and DeFi architecture, DAO governance, cross-chain data sharing, healthcare and insurance embodiments, and multi-sector digital-asset operations.

Additional earlier finance and infrastructure roots preserved for contextual, implementation, or branch support include: Ser. No. 19/060,663 (risk-controlled transaction authorization, hardware-rooted signing, offline approval, and audit reconstruction); Ser. No. 19/067,732 (sovereign financial identity, domain deployment, reversible clearing, federated AI risk control, zero-knowledge audit, and post-quantum upgrade path); Ser. No. 19/066,022 (banking risk control, multi-signature approval, distributed auditing, automated compliance, collateralization, and incentive mechanisms); Ser. No. 19/066,179 (orchestration backbone, routing contracts, governance architecture, cross-chain adapters, and AI, privacy, and energy-management infrastructure); Ser. No. 19/067,845 (credit scoring, multi-party computation, zero-knowledge proof, AI risk analytics, and data governance); Ser. No. 19/067,888 (financial interoperability, second-level domain identity, standards bridge, quantum key distribution, quantum random-number generation, and dual-layer authorization); and Ser. No. 19/067,936 (supply-chain provenance, anti-counterfeiting, inventory analytics, and supply-chain finance).

Related branches preserved for exchange, digital land, payment-to-mint, upgrade governance, registry, rollback, and market infrastructure include: Ser. No. 19/403,879 (exchange infrastructure, securities standards, asset registry, and domain-based instruments); Ser. No. 19/411,327 (payment-to-mint architecture, terminal behavior minting, merchant-zero-fee operation, and payment governance); Ser. No. 19/073,040 (upgradeable smart contracts, proxy-implementation architecture, role-based access control, multi-signature version control, rollback, and audit security); Ser. No. 19/073,778 (digital-land, NFT parcel governance, and hierarchical subdomain governance); Ser. No. 19/448,144 (domain-name resolution, policy-governed naming, resolution receipts, object binding, and bounded rollback); and Ser. No. 19/058,739 (domain and namespace lattice, decentralized finance, privacy, and compliance infrastructure).

Selected related PCT branches in the broader ATMS and BEI ecosystem include PCT/IB2025/051936 (ATMS banking centers), PCT/IB2025/052095 (ENHANCEDSWITCHCODE), PCT/IB2025/052147 (ATMScomGreenMining), PCT/IB2025/052151 (BankingRiskControl), PCT/IB2025/052235 (AiBlockchainCrossborder), PCT/IB2025/052237 (Web3DigitalBanking), PCT/IB2025/052251 (GlobalFinancialInfrastru), PCT/IB2025/053321 (GenesisCurrency), PCT/IB2025/053329 (TokenSystemCurrency24HWS), and PCT/IB2025/053385 (VaultIDLiveIDDAO). These materials provide technical background regarding domain-based financial endpoints, sovereign banking, settlement, identity, behavior-linked value systems, and risk control.

Where permitted by law and to the extent not inconsistent with the present disclosure, the disclosures of the above applications may be incorporated by reference for contextual, implementation, branch, or ecosystem support; however, such incorporation is not intended to substitute for an Application Data Sheet domestic benefit claim, nor to cure a lack of written-description support where required by applicable law.

### TECHNICAL FIELD

The invention relates to digital identity, domain-resolved banking and treasury systems, secure transaction processing, distributed ledger systems, interoperable settlement infrastructure, cryptographic policy enforcement, behavior-evidence processing, and programmable asset and entitlement management.

More particularly, the invention concerns a computer-implemented ATMS platform that combines decentralized identity authentication, machine-verifiable policy control, domain and subdomain routing, behavior-evidence ingestion, prudential profile evaluation, tokenized rights management, co-ownership participation tracking, and multi-rail settlement under a unified receipt and audit architecture.

### BACKGROUND OF THE INVENTION

Modern financial systems remain fragmented across identity, payments, lending, governance, collateral, treasury, and settlement environments. Customers, operators, institutions, and regulators are forced to reconcile records from disconnected systems that do not share a consistent evidence path or policy lineage.

Existing systems often separate identity verification, risk control, compliance screening, capital treatment, issuance control, and settlement into isolated layers. This fragmentation creates latency, duplicate compliance overhead, weak auditability, limited rollback control, and poor portability across institutions or jurisdictions.

Conventional banking and token platforms also treat domain names, subdomains, digital-land rights, registry objects, node manifests, and deployment packages as disconnected from transaction authorization and prudential control. As a result, a domain may point to a service endpoint without cryptographically binding that endpoint to a specific policy profile, treasury permission set, or deployment manifest.

Many token systems further fail to convert verified real-world or machine-observed behavior into controlled issuance permissions that are visible to the same policy and settlement spine that governs transfers, collateralization, and liquidation. Fraud detection or risk scoring often occurs outside the transaction path, leaving no deterministically linked receipt showing why issuance or settlement was allowed.

Existing co-ownership or participation-token systems likewise tend to allocate rights without binding contribution evidence, node-level revenue data, treasury reserves, governance permissions, and settlement controls into one coordinated state transition. This makes it difficult to evaluate or transfer a node, a franchise-style deployment, or a field-of-use module as a coherent technology asset.

A need therefore exists for a machine architecture capable of authenticating a subject or object, applying machine-verifiable policy and prudential profiles, ingesting verified behavior evidence, controlling issuance or reserve updates, selecting among multiple settlement rails, generating linked receipts, and deploying the same control spine across domain-resolved banking nodes, treasury nodes, lending nodes, and transferable module packages.

A further need exists for an architecture that can preserve earlier roots in identity, finance, governance, registry, security, and sector branches while presenting a coherent, technically useful, and commercially transferable system for licensing, assignment, field-of-use deployment, or regulated institutional adoption.

### SUMMARY OF THE INVENTION

In one aspect, the invention provides a computer-implemented system including a namespace registry, an identity-anchor module, a behavior-evidence ingestion module, a prudential profile engine, a collateral and treasury module, a transaction authorization and issuance engine, a multi-rail settlement module, and a linked-receipt generator. These modules cooperate to generate a single machine-verifiable spine for identity, proof, authorization, issuance, collateral, and settlement.

In another aspect, the invention provides a method in which a subject identity anchor or object anchor is authenticated, an event or request is received, one or more signed endpoint or node-manifest records are resolved, a policy bundle and prudential profile are applied, a bounded authorization outcome and issuance permission are selected, and cryptographically linked decision, issuance, and settlement receipts are recorded.

In another aspect, the invention provides machine-readable instructions for implementing the same architecture on one or more computing systems, including cloud deployments, edge terminals, validator nodes, treasury nodes, exchange gateways, registry nodes, institution gateways, and franchise-style subdomain banking nodes.

The namespace registry stores signed endpoint records or node manifests that map a domain, subdomain, namespace token, or other human-readable financial locator to one or more executable settlement endpoints, rail constraints, public keys, policy identifiers, prudential profile identifiers, treasury permissions, and deployment metadata. This allows a transaction origin, regulatory posture, and routing context to be bound together at request time.

The identity-anchor module binds a user, enterprise, treasury, institution, or device to one or more decentralized identifiers, verifiable credentials, compliance attestations, biometric proofs, hardware-backed credentials, or zero-knowledge proofs. The module can maintain revocation status, proof freshness, role information, and selective-disclosure constraints.

The behavior-evidence ingestion module receives digitally signed event records, terminal-originated payment events, service-completion proofs, contribution events, environmental or health events, merchant activity proofs, device-originated measurements, or other machine-verifiable data that may be used under policy control to update eligibility, risk posture, issuance permissions, reserve allocations, or participation indices.

The prudential profile engine maintains signed and versioned profiles that specify risk buckets, issuance caps, reserve requirements, rollback limits, collateral requirements, regulator-visibility rules, disclosure membranes, or node-activation constraints. In some embodiments, the prudential profile engine converts verified behavior evidence and collateral state into one or more machine-readable capital-treatment parameters or issuance permissions.

A collateral and treasury module tracks tokenized assets, non-fungible tokens, stable-value balances, reserves, tokenized real-world assets, or other encumerable value units and associates them with reservation status, liquidation thresholds, valuation sources, reserve ratios, and permitted use constraints. A transaction authorization and issuance engine uses transaction attributes, endpoint characteristics, credential quality, behavior evidence, collateral state, market conditions, bridge conditions, fraud indicators, and policy-defined thresholds to generate a risk vector and an issuance or settlement decision.

A multi-rail settlement module chooses among a base-layer blockchain rail, a cross-chain rail, a layer-2 rail, an internal net-settlement rail, or an off-chain or hybrid institutional rail. A linked-receipt generator produces a decision receipt, an issuance receipt where applicable, and a settlement receipt that share a common digest, chain of digests, or comparable linkage so that later audit reconstruction can prove which endpoint record, policy bundle, prudential profile, and evidence set controlled the resulting action.

In still further aspects, the invention provides optional extensions for payment-to-mint conversion, contribution-indexed participation tokens, revenue-sharing distributions, digital-land and subdomain governance, upgradeable contract control, foreign-exchange optimization, AI-driven credit and fraud management, quantum-secure communication, and deployment-package manifests for licensing or transfer of the system as modular but coherent technology layers.

The invention thereby improves computer functionality by reducing fragmentation, enforcing machine-verifiable policy and prudential validity inside the authorization and issuance path, generating tamper-evident linked receipts, enabling domain-namespace driven routing and entitlement binding, and providing a single technical spine capable of licensing, transfer, or deployment across multiple commercial, institutional, and sovereign contexts.

The same integrated technical architecture also improves the valuation and transferability of related intellectual-property assets because the system is organized as a modular but coherent stack with identifiable core parents, related branches, transferable node manifests, and sector-application embodiments.

### BRIEF DESCRIPTION OF THE DRAWINGS

FIG. 1 illustrates an overall ATMS CIP architecture including identity, policy, behavior-evidence, prudential-profile, treasury, settlement, and receipt layers.

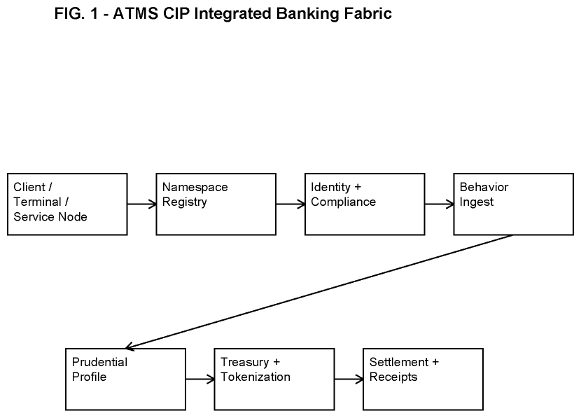

FIG. 2 illustrates a domain-resolved node-manifest structure for root domains, subdomains, or franchise-style banking nodes.

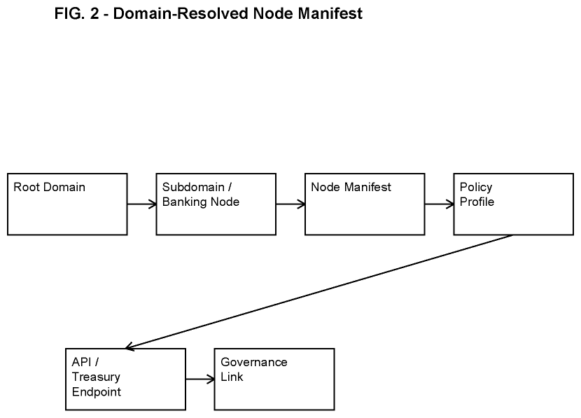

FIG. 3 illustrates a behavior-to-issuance pipeline including evidence normalization, prudential evaluation, issuance permissioning, and linked receipt generation.

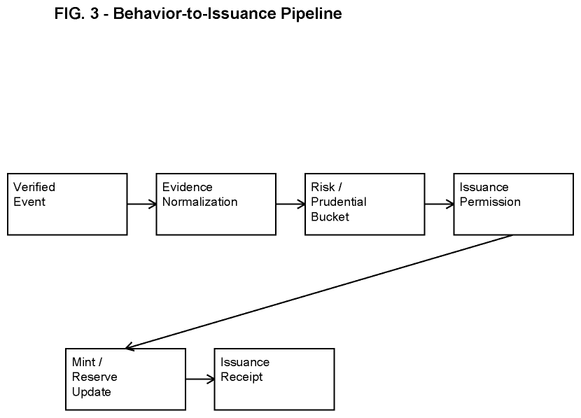

FIG. 4 illustrates linked decision, issuance, and settlement receipts with bounded rollback controls.

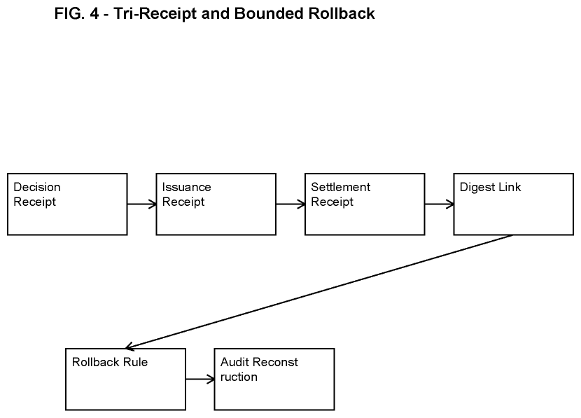

FIG. 5 illustrates a co-ownership and revenue-sharing node architecture with contribution indexing and participation-token distribution.

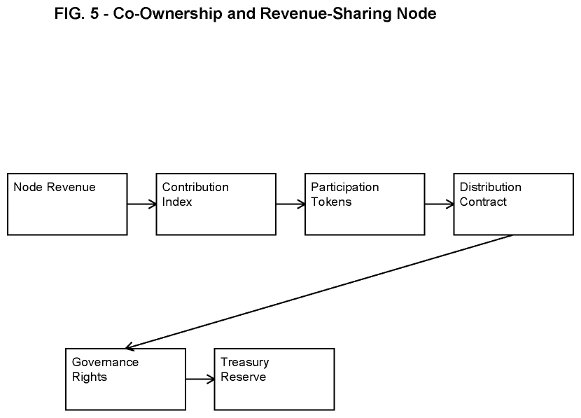

FIG. 6 illustrates multi-rail and foreign-exchange route selection including base-layer, layer-2, bridge, and hybrid rails.

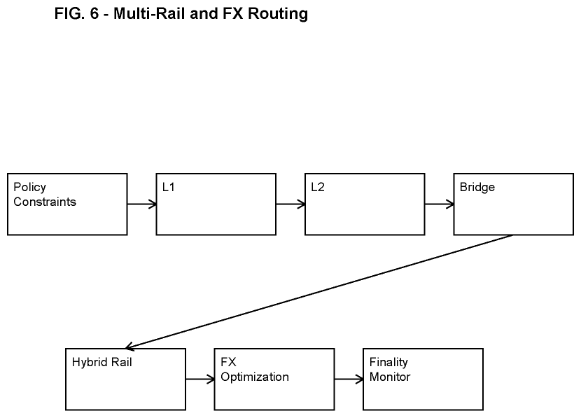

FIG. 7 illustrates collateralization and real-world-asset workflows including valuation, pledge, reserve, lending, and liquidation paths.

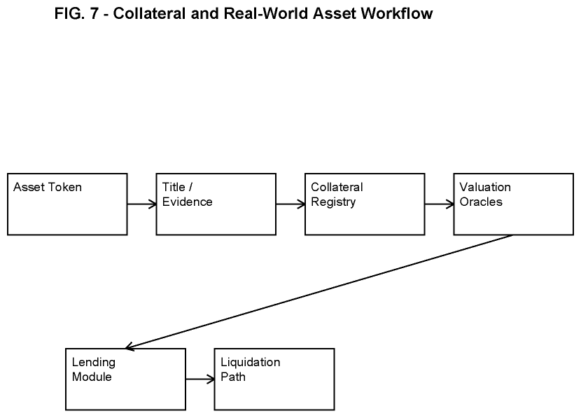

FIG. 8 illustrates regulatory-profile and sandbox activation workflows for policy updates.

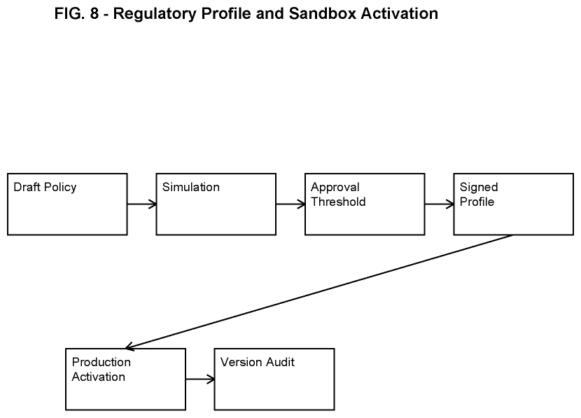

FIG. 9 illustrates a transferable module-package manifest used for deployment, validation, and field-specific activation.

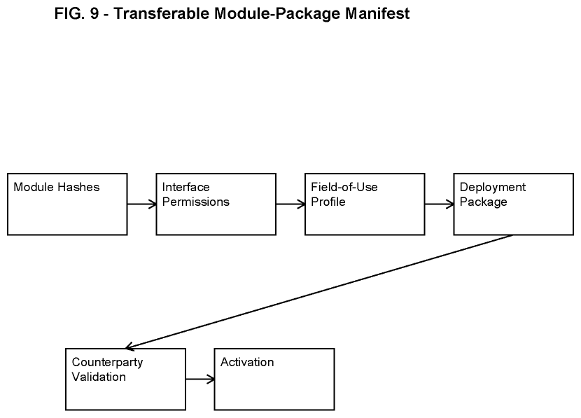

FIG. 10 illustrates computing hardware, edge terminals, server nodes, registry nodes, validator nodes, institution gateways, and external service rails.

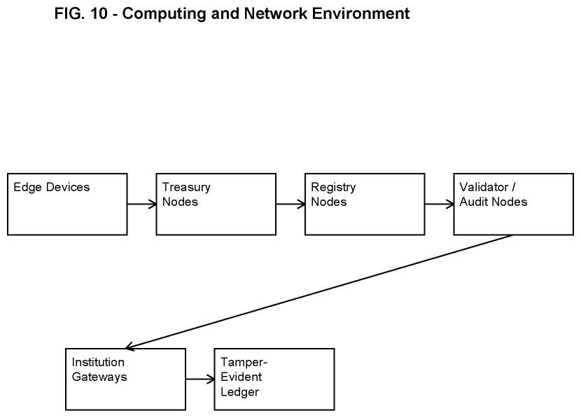

### DETAILED DESCRIPTION OF THE INVENTION

### Definitions and Drafting Conventions

As used herein, a subject may refer to a person, device, enterprise, institution, regulator, sovereign entity, terminal operator, franchise-node operator, or any actor capable of holding or being associated with an identity anchor, credential, token, entitlement, treasury permission, or authorization state.

As used herein, an identity anchor refers to a persistent machine-verifiable root association, which may include a decentralized identifier, public-key reference, wallet-bound credential, non-transferable token, verifiable credential, or other anchored identity representation.

As used herein, a node manifest refers to a signed or integrity-protected data structure that associates a domain identifier, subdomain identifier, parcel identifier, or other namespace label with one or more target endpoints, keys, policy references, prudential profiles, treasury permissions, revenue-routing rules, or deployment constraints.

As used herein, a prudential profile refers to a signed, versioned rule set comprising issuance caps, reserve ratios, risk thresholds, disclosure rules, settlement permissions, rollback constraints, reserve treatment, remediation directives, or bounded-action directives.

As used herein, a behavior evidence record refers to a digitally signed or otherwise machine-verifiable record reflecting an event, contribution, action, service completion, device signal, or policy-relevant activity that may be used, under a prudential profile, to affect eligibility, risk treatment, issuance permissions, or participation indices.

As used herein, a decision receipt means a cryptographically verifiable receipt for an authorization decision, an issuance receipt means a cryptographically verifiable receipt for minting, reserve allocation, or participation-token allocation, and a settlement receipt means a cryptographically verifiable receipt for a transfer, exchange, liquidation, or settlement transition.

### System Spine and Control Flow

In one embodiment, a human-readable identifier, subdomain identifier, or other namespace label is provided to a namespace resolver. The resolver returns a signed node manifest containing identity, policy, prudential, treasury, issuance, audit, and settlement endpoint information.

In one embodiment, an identity module authenticates a subject identity anchor or object anchor by verifying a decentralized identifier, public-key credential, verifiable credential, biometric approval, hardware-rooted credential, or predicate-based proof.

In one embodiment, an event-ingestion module receives a digitally signed event record, transaction request, evidence commitment, terminal-originated payment event, service-completion record, route-selection request, collateralization request, liquidation trigger, registry update, or application-layer event.

In one embodiment, a profile-selection module loads a signed, versioned policy bundle and prudential profile associated with the resolved node manifest and evaluates the incoming event or request under source authorization rules, role rules, issuance caps, reserve rules, jurisdictional constraints, privacy rules, remediation directives, rollback limits, or bounded authorization outcomes.

In one embodiment, an authorization and issuance engine executes a controlled state transition to authorize a protected action, optionally permit issuance, reserve allocation, or participation-token allocation, generate a decision receipt and issuance receipt, and anchor one or more digests of the transition in an append-only structure.

In one embodiment, a clearing and settlement module subsequently performs listing, transfer, exchange, conversion, collateralization, liquidation, or settlement and issues a settlement receipt linked to the same or a related digest reference.

In one embodiment, a policy-governed object may be a domain token, parcel token, evidence token, collateral token, registry entry, franchise token, sub-bank participation token, terminal event, payment right, minting right, or license-gated artifact.

### Behavior Evidence, Prudential Translation, and Controlled Issuance

Verified behavior evidence may include merchant transaction completion, education or training completion, environmental contribution, health-compliance milestone, logistics completion, device-originated telemetry, treasury-service contribution, or other machine-verifiable activity. Each evidence record can carry a source identifier, timestamp, proof reference, anti-replay value, and policy tag.

The prudential profile engine may convert behavior evidence into one or more contribution scores, issuance permissions, reserve-weight factors, caps, delay periods, or remediation requirements. This translation can depend on source quality, proof freshness, fraud indicators, collateral support, prior issuance volume, treasury reserve state, or jurisdictional rules.

In some embodiments, the system does not mint or allocate value immediately upon receiving evidence. Instead, the system evaluates the evidence against a signed profile that specifies whether the evidence supports immediate issuance, deferred issuance, reserve-only recognition, score-only recognition, or denial. This allows behavior-linked value creation to remain bounded by machine-readable risk and reserve controls.

In some embodiments, the prudential profile engine maintains one or more machine-readable capital-treatment parameters, reserve ratios, or risk buckets associated with a subject, node, or asset class. Such parameters can be recalculated when collateral values, fraud indicators, or governance-approved policy versions change.

In some embodiments, behavior-linked issuance is combined with tokenized collateral so that a portion of issuance is contingent upon continued collateral sufficiency, proof validity, or reserve availability. The linked receipts permit later reconstruction of why issuance occurred and whether any subsequent rollback or remediation was authorized.

### Domain-Resolved Node Deployment and Digital Real Estate

A root domain, subdomain, parcel identifier, or other namespace label may correspond to a treasury node, lending node, merchant node, franchise-style banking node, or regulated institutional node. The node manifest for each node can define local endpoints, policy references, reserve permissions, contribution-index settings, fee-routing rules, or participant classes.

In one embodiment, a franchise-style node is created by issuing a signed subdomain or node-manifest record from a parent domain. The child node can inherit required controls from the parent while maintaining localized parameters for jurisdiction, language, product scope, reserve treatment, or authorized asset classes.

A node manifest may also reference a deployment package or module manifest defining required software modules, interface permissions, receipt schemas, or audit hooks. This permits a counterparty acquiring or licensing a node deployment to validate that the installed system corresponds to a signed package profile.

In digital-land or parcel embodiments, a domain or subdomain may also function as a programmable real-estate style endpoint for identity, service deployment, treasury permissions, inherited rights, or delegated service rights. Freeze, renewal, partition, inheritance, and reassignment rules may be policy-governed and receipt-linked.

### Co-Ownership Participation Tokens and Revenue Sharing

In one embodiment, a contribution-index engine computes a subject-specific or node-specific contribution measure from verified behavior evidence, transaction volume, service performance, stake, reserve contribution, or other policy-approved signals.

In one embodiment, the system allocates co-ownership participation tokens or other participation records to subjects whose contribution measures satisfy profile-defined thresholds. The allocation may create governance rights, revenue-sharing rights, discount rights, or other bounded entitlements associated with the node.

In one embodiment, node revenue or treasury inflows are routed to a distribution contract or treasury service that allocates portions among reserve accounts, operating accounts, governance-controlled pools, parent-node accounts, and participation-token holders according to signed rules linked to the node manifest.

Because contribution evidence, prudential profiles, allocation decisions, and settlement execution share a linked receipt chain, a later acquirer or auditor can verify the provenance of participation rights and associated revenue flows. This improves transferability of the node or module as a coherent technology asset.

### Linked Receipts, Rollback, and Audit Reconstruction

A linked receipt chain may include a decision receipt, an issuance receipt, and a settlement receipt. Each receipt can include a request identifier, subject reference, node-manifest identifier, policy-bundle version, prudential-profile version, risk-vector digest, selected route, issuance action, reserve action, and settlement execution reference.

In some embodiments, a bounded rollback engine applies rollback depth limits, span limits, impact-set constraints, anti-domino rules, reserve guards, or machine-readable remediation directives. The engine can determine whether an issuance, settlement, or participation allocation may be reversed, partially reversed, or only remediated through a forward corrective action.

Tri-header or multi-header receipt structures may be used to preserve user, operator, and system or regulator views of an event while still linking them cryptographically. The public ledger may store only digests or encrypted references while fuller detail remains in access-controlled stores.

### Multi-Rail Routing, FX Optimization, and Hybrid Settlement

Route selection may evaluate latency, liquidity depth, foreign-exchange volatility, fees, compliance risk, bridge risk, congestion, reserve state, and fraud probability to select an execution path. Candidate rails can include base-layer blockchain networks, layer-2 systems, bridges, internal net-settlement rails, or regulated hybrid rails that interact with institutions.

Currency exchange optimization may use predictive models to time or structure execution in a way that reduces hidden conversion costs, improves liquidity use, or reduces settlement delay. The selected route and optimization inputs can be preserved in the linked receipt chain.

Assets, parcels, tokens, or rights may be collateralized using AI-driven valuation models, dynamic collateral-ratio management, and automated risk thresholding. Liquidation may be triggered automatically when risk metrics, valuation changes, or threshold conditions are satisfied, subject to profile limits, liquidity safeguards, or bounded remediation logic.

### Transferable Module Packages and Commercial Deployment

In one embodiment, a module-package manifest stores signed hashes or comparable integrity values for core modules such as namespace routing, identity verification, prudential profile control, contribution indexing, co-ownership allocation, settlement adapters, or receipt generation. The manifest can additionally store interface permissions, version dependencies, and field-specific activation controls.

A deployment package based on the module-package manifest may be validated by a counterparty before acquisition, assignment, or field-of-use activation. The counterparty can verify that the deployed package corresponds to the referenced manifest, policy profile, and node-manifest expectations without reviewing all private operational data.

The same manifest architecture improves licensing and transfer because a licensor can enable a subset of modules, rails, asset classes, or receipt features while preserving cryptographic proof of what was actually activated. The technical package remains modular without losing coherent linkage to the underlying control spine.

### Security Infrastructure and Upgrade Governance

In one embodiment, one or more smart-contract components are upgradeable using a proxy-implementation architecture in which state is preserved and implementation pointers are switched under policy-controlled conditions. Multi-signature approval, role-based access control, version registries, rollback to stable versions, sandbox testing, and anomaly-triggered freeze or lockdown can be used to secure upgrades.

Communication and identity verification may be protected using post-quantum, quantum-resistant, or hybrid cryptographic methods, including lattice-based, code-based, hash-based, threshold-signature, secure-element, or hardware-backed key-release techniques.

Cross-chain or cross-ledger validation may be achieved through light-client proofs, relay services, bridge attestations, validator-backed interoperability layers, or institution-facing adapters. Oracle services may be used for exchange rates, pricing, reserve data, external event confirmations, real-world signals, or settlement conditions, and oracle outputs may themselves be policy-bounded and receipt-linked.

Digital Financial Passport and Self-Minting Vault Embodiments. In optional embodiments preserved from earlier ATMS financial-system branches, a resolved ATMS domain or subdomain operates as a digital financial passport bound to a subject identity anchor, wallet, account state, or credential set. The passport may be used to open compliant payment, lending, collateral, treasury, or settlement workflows across multiple nodes without requiring repeated full onboarding at each destination endpoint.

In optional embodiments, a vault object stores collateral, reserve balances, tokenized assets, or entitlement limits and cooperates with the prudential profile engine to determine whether a self-minting action, a bounded issuance action, or an adaptive loan-limit update may occur. The engine may consider verified transaction history, behavior evidence, NFT or real-world-asset valuations, reserve sufficiency, fraud indicators, and policy constraints before permitting minting, loan approval, or liquidation.

Global Chain and Sector-Node Embodiments. In further embodiments preserved from earlier global-chain ecosystem branches, the same domain-resolved control spine can activate sector nodes for supply-chain provenance, healthcare data rights, insurance-claim automation, e-commerce operations, public-service workflows, or other cross-sector digital-asset operations. Each sector node may inherit identity, receipt, route-selection, policy, audit, and treasury controls while enabling field-specific data models, permissions, and risk metrics.

### Industrial Applicability and Commercial Use

The invention is industrially applicable to digital identity, banking, payments, exchange and settlement, collateral management, regulated issuance control, digital-land and registry systems, government services, supply-chain provenance, device and asset identity, smart-contract infrastructure, and policy-controlled licensing systems.

The system can be deployed as a modular stack, including identity modules, policy-evaluation modules, prudential-profile modules, namespace-routing modules, contribution-index modules, payment-to-issuance modules, collateral and liquidation modules, exchange and securities modules, co-ownership participation modules, or sector-application modules.

The architecture is suitable for transfer, assignment, field-of-use licensing, or sovereign or enterprise deployment because the core spine is technically coherent while allowing node-level specialization, profile-level variation, and package-level activation control.

### Additional Embodiments and Variations

The modules described herein may be implemented in software, firmware, hardware, trusted execution environments, hardware security modules, mobile devices, browser clients, cloud services, validators, ledger nodes, exchange gateways, or combinations thereof.

A ledger used herein may be public, private, consortium, permissioned, permissionless, append-only, or hybrid, and may store either full data, commitments, hashes, or selective references.

The same architecture may be applied to banking nodes, patents, domains, digital works, APIs, datasets, credentials, parcel rights, supply-chain objects, terminal receipts, or policy-governed service rights.

Unless expressly stated otherwise, no element, action, outcome, or sequence is required to occur in the precise order described, and modules may be combined, distributed, virtualized, or omitted while preserving the invention as recited in the claims.

The scope of protection is defined by the claims and their lawful equivalents.

1. A computer-implemented domain-resolved banking and asset orchestration system, comprising:
a namespace registry storing signed endpoint records or node manifests that map a domain identifier, subdomain identifier, or other human-readable financial locator to one or more executable service endpoints, a public-key reference, a policy-bundle identifier, and a prudential-profile identifier;
an identity-anchor module configured to verify a decentralized identity credential, compliance attestation, or zero-knowledge proof associated with a subject initiating a transaction request or evidence submission;
a behavior-evidence ingestion module configured to receive and verify signed behavior evidence records associated with the subject or a node;
a prudential profile engine configured to apply a signed, versioned prudential profile to the transaction request or evidence submission and to generate at least one issuance permission, reserve action, or risk bucket using the signed behavior evidence records and a current state of at least one collateral or treasury object;
a transaction authorization and issuance engine configured to authorize or deny the transaction request and, when permitted by the prudential profile, to update a treasury state, reserve state, or token state;
a route selector configured to select one settlement rail from a plurality of settlement rails comprising a base-layer blockchain rail, a cross-chain rail, a layer-2 rail, or an off-chain or hybrid settlement rail;
a settlement coordinator configured to execute an authorized transaction on the selected settlement rail while updating settlement state and at least one treasury, reserve, or collateral state in linked form; and
a linked-receipt generator configured to generate a decision receipt and a settlement receipt and, when an issuance or reserve update occurs, an issuance receipt, the receipts being linked by a common digest, digest chain, or comparable linkage.

2. The system of claim 1, wherein each node manifest further stores a jurisdiction profile, revenue-routing rule, interface permission set, or deployment metadata used to activate a subdomain or franchise-style banking node.

3. The system of claim 1, wherein the identity-anchor module issues or verifies a digital financial passport bound to a domain or subdomain identifier, a decentralized identifier, a verifiable credential, a non-transferable identity token, a device attestation, or a zero-knowledge proof indicating satisfaction of a know-your-customer, anti-money-laundering, sanctions, role, or geography condition.

4. The system of claim 1, wherein the prudential profile engine computes, from the signed behavior evidence records and the current state of the at least one collateral or treasury object, a machine-readable capital-treatment parameter, issuance cap, reserve ratio, risk bucket, adaptive credit score, loan-limit parameter, or liquidation threshold used by the transaction authorization and issuance engine.

5. The system of claim 1, further comprising a contribution-index engine and a vault-control module configured to calculate a participation measure from verified behavior evidence, transaction volume, reserve contribution, service performance, or collateral state and to cause allocation of co-ownership participation tokens, bounded issuance permissions, or self-minting vault entitlements according to the participation measure.

6. The system of claim 1, wherein the linked-receipt generator produces a multi-view receipt structure comprising at least a subject-facing view, an operator-facing view, or a regulator-facing view that remain cryptographically linked while exposing different data scopes and preserving a common digest for audit reconstruction.

7. The system of claim 1, further comprising a bounded rollback engine configured to apply rollback depth limits, impact-set constraints, reserve guards, or remediation directives to a previously authorized issuance or settlement action.

8. A computer-implemented method for processing a domain-resolved banking event, comprising:
receiving, from a domain-resolved endpoint, terminal, service node, or programmatic caller, a transaction request or behavior evidence record;
resolving a domain identifier or subdomain identifier associated with the transaction request or behavior evidence record to a signed endpoint record or node manifest;
verifying, by an identity-anchor module, a decentralized identity credential, compliance attestation, or zero-knowledge proof for a subject associated with the transaction request or behavior evidence record;
loading, from a profile store, a signed, versioned prudential profile associated with the signed endpoint record or node manifest;
generating, by a prudential profile engine, at least one issuance permission, reserve action, or risk bucket using the transaction request or behavior evidence record, the signed endpoint record or node manifest, the decentralized identity credential, and a current state of at least one collateral or treasury object;
authorizing or denying, by a transaction authorization and issuance engine, the transaction request or behavior evidence record according to the signed, versioned prudential profile;
selecting, by a route selector and based on the authorization result, one settlement rail from a plurality of settlement rails comprising a base-layer blockchain rail, a cross-chain rail, a layer-2 rail, or an off-chain or hybrid settlement rail;
when the transaction request or behavior evidence record is authorized, updating a settlement state and at least one treasury, reserve, token, or collateral state in linked form; and
generating a decision receipt and a settlement receipt and, when an issuance or reserve update occurs, an issuance receipt linked by a common digest, digest chain, or comparable linkage.

9. The method of claim 8, wherein generating the at least one issuance permission, reserve action, or risk bucket comprises applying a signed contribution-index rule, issuance cap, reserve ratio, delay period, remediation directive, interest-setting parameter, mint-threshold parameter, or liquidation-control parameter defined in the prudential profile.

10. The method of claim 8, wherein the behavior evidence record comprises a terminal-originated payment event, a merchant service-completion proof, an education or training completion event, an environmental contribution record, a supply-chain or healthcare event record, a collateral-deposit event, an NFT-pledge event, a device-originated signal, or another signed machine-verifiable activity record.

11. The method of claim 8, wherein authorizing the transaction request or behavior evidence record comprises permitting immediate issuance, deferred issuance, reserve-only recognition, score-only recognition, loan approval, collateral remediation, payment settlement, or denial according to the prudential profile.

12. The method of claim 8, further comprising computing a participation measure and allocating co-ownership participation tokens or another bounded participation entitlement according to the participation measure, and activating a sector node or subdomain node that inherits at least one policy, receipt, or treasury rule from a parent node manifest.

13. The method of claim 8, further comprising validating a module-package manifest storing signed hashes or comparable integrity values for activated modules before activating a licensed, transferred, or field-specific deployment package.

14. The method of claim 8, wherein the signed endpoint record or node manifest includes a subdomain-node configuration and the method further comprises activating a child banking node that inherits one or more controls from a parent node while maintaining localized parameters for jurisdiction, language, product scope, or authorized asset classes.

15. A non-transitory computer-readable medium storing instructions that, when executed by one or more processors of a domain-resolved banking platform, cause the one or more processors to:
receive a transaction request or behavior evidence record from a terminal, wallet, application, service node, or programmatic caller;
resolve a human-readable financial locator to a signed endpoint record or node manifest containing routing metadata and a prudential-profile identifier;
verify a subject identity anchor and a compliance proof;
obtain treasury, reserve, collateral, or market evidence associated with the transaction request or behavior evidence record;
generate a risk vector and an issuance, reserve, or settlement-control result under a signed prudential profile;
authorize or deny the transaction request or behavior evidence record;
when authorization is obtained, perform a coordinated state transition that updates a settlement state and at least one treasury, reserve, token, or collateral state in linked form; and
generate and anchor a decision receipt and a settlement receipt and, when applicable, an issuance receipt linked by a common digest, digest chain, or comparable linkage.

16. The non-transitory computer-readable medium of claim 15, wherein the instructions further cause the one or more processors to compare multiple candidate settlement rails using at least cost, congestion, expected finality, bridge risk, foreign-exchange effect, policy restrictions, or destination-node constraints before selecting a settlement rail.

17. The non-transitory computer-readable medium of claim 15, wherein the instructions further cause the one or more processors to use a post-quantum signature scheme, threshold-signature scheme, secure-element release condition, or hardware-backed key release condition when generating or verifying at least one receipt, execution message, or node-activation message.

18. The non-transitory computer-readable medium of claim 15, wherein the instructions further cause the one or more processors to process a tokenized real-world asset or non-fungible token as collateral, obtain valuation data from one or more oracle sources, and trigger liquidation, remediation, reserve adjustment, self-minting-vault control, or adaptive loan-limit control according to the prudential profile.

19. The non-transitory computer-readable medium of claim 15, wherein the instructions further cause the one or more processors to store only a digest or encrypted reference in a public tamper-evident data structure while storing fuller transaction detail, sector-node detail, supply-chain detail, healthcare detail, or insurance-claim detail in an access-controlled data store.

20. The non-transitory computer-readable medium of claim 15, wherein the instructions further cause the one or more processors to publish an updated signed prudential profile after simulation, sandbox validation, governance approval, multi-signature authorization, or regulator-approved profile activation and to apply the updated signed prudential profile to a subsequent transaction request, behavior evidence record, or sector-node activation.
